(19) United States
(12) Patent Application Publication
(10) Pub. No.: US 2024/0140741 A1
(43) Pub. Date: May 2, 2024

(54) DOCKING CONTROL SYSTEM FOR VEHICLE AND BUILDING AND METHOD THEREFOR

(71) Applicants: Hyundai Motor Company, Seoul (KR); Kia Corporation, Seoul (KR)

(72) Inventors: Ki Hyun CHOI, Yongin-Si (KR); Ji Hyun SONG, Suwon-Si (KR); Hyung Sik CHOI, Seoul (KR); Sun In YOU, Yesan-Eup (KR); Sang Heon LEE, Seoul (KR); Jin Ho HWANG, Cheonan-Si (KR); Dong Eun CHA, Hwaseong-Si (KR); Won Chan LEE, Suwon-Si (KR)

(73) Assignees: Hyundai Motor Company, Seoul (KR); Kia Corporation, Seoul (KR)

(21) Appl. No.: 18/117,104

(22) Filed: Mar. 3, 2023

(30) Foreign Application Priority Data
Oct. 27, 2022 (KR) 10-2022-0140627

(51) Int. Cl. B65G 69/28; G01S 17/06; G01S 17/931

(52) U.S. Cl. CPC B65G 69/2882; G01S 17/06; G01S 17/931; B65G 2203/0283; B65G 2203/042

(57) ABSTRACT

A docking control system for a vehicle and a building and a method therefor, includes a plurality of sensors including a vehicle sensor and a gate sensor, and a controller, when a vehicle approaches a gate, which controls the plurality of sensors to set amount of movement of the vehicle, to move the gate so that a vehicle door and the gate are brought into close contact with each other, and when positional satisfaction between the vehicle door and the gate is achieved, which opens the vehicle door and the gate so that an indoor space of the vehicle and an indoor space of the building are connected each other into one space.

### CROSS REFERENCE TO RELATED APPLICATION

The present application claims priority to Korean Patent Application No. 10-2022-0140627, filed Oct. 27, 2022, the entire contents of which is incorporated herein for all purposes by this reference.

### BACKGROUND OF THE PRESENT DISCLOSURE

### Field of the Present Disclosure

The present disclosure relates to a docking control system for a vehicle and a building and a method therefor. More particularly, the present disclosure relates to a docking control system for a vehicle and a building and a method therefor, wherein when the vehicle is docked with the building, the system is configured for setting the amount of movement of the vehicle and a gate for achieving docking of the vehicle by use of a plurality of sensors and of compensating a docking error between the vehicle and the building.

### Description of Related Art

Recently, as interest in electric vehicles and autonomous vehicles has increased, various utilizes and forms of vehicles have been developed together. In the case of autonomous vehicles, connectivity between each vehicle and various other environments is important as passengers in the vehicle can freely move in the indoor space of the vehicle.

Accordingly, a concept in which the indoor space of the vehicle may be expanded and utilized as a residential space when the vehicle is docked with a building while the vehicle and the residential space are connected to each other is realistic possibility. Here, during docking of the vehicle and the building, because movement of the building is impossible, the vehicle should be parked at a position where the vehicle may be connected to a gate.

However, it is difficult to perform precise distance measurement required for the vehicle to be moved to the position of the gate, and when parking of the vehicle is completed and it is difficult to move the vehicle to the position of the gate due to outside obstacles, movement of the gate may be required.

Therefore, there is a demand for a method to ensure that a vehicle and a building are docked without errors, by use of a plurality of sensors.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a docking control system for a vehicle and a building and a method therefor, wherein when a vehicle and a building are docked with each other, the docking control system is configured to set the amount of movement of the vehicle and a gate, which is required for docking of the vehicle, by use of the plurality of sensors and to compensate a docking error between the vehicle and the building.

The technical problem of the present disclosure is not limited to the abovementioned, and other problem not mentioned will be clearly understood by those skilled in the art from the description below.

As a means for achieving the above-described technical problem, according to various aspects of the present disclosure, there is provided a docking control system for a vehicle and a building, the docking control system including: a plurality of sensors including a vehicle sensor and a gate sensor; and a controller, when a vehicle approaches a gate, which may control the plurality of sensors to set amount of movement of the vehicle, to move the gate so that a vehicle door and the gate may be brought into close contact with each other, and when positional satisfaction between the vehicle door and the gate is achieved, which may open the vehicle door and the gate so that the indoor space of the vehicle and the indoor space of a vehicle may be connected each other into one space.

For example, the vehicle sensor may include a Light Detection and Ranging (LiDAR) sensor, and the gate sensor may include a gate position sensor configured to detect a position of the gate and a gate contact sensor configured to detect whether or not the vehicle door and the gate are in contact with each other.

For example, the controller may be configured to determine positions of the vehicle door and the gate by the LiDAR sensor of the vehicle and the gate position sensor to set the amount of movement of the vehicle.

For example, the amount of movement of the vehicle may include an amount of longitudinal movement of the vehicle and an amount of height increase and decrease of the vehicle.

For example, the controller may be configured to control the vehicle sensor and the gate position sensor, and when an obstacle is detected, the controller may stop movement of the gate.

For example, the controller may be configured to control the gate contact sensor, and when the vehicle door is in contact with a side wall of the gate, the controller may stop opening of the vehicle door.

For example, the controller may be configured to set amount of transverse movement of the gate, and move the gate according to the set amount of traverse movement, so that the vehicle door and the gate may be brought into close contact with each other.

For example, when the positional satisfaction between the vehicle door and the gate is achieved, the controller may open the gate after the vehicle door is opened.

For example, the vehicle door may be configured to be opened while being rotated from an inner space of the gate.

For example, a vehicle body of the vehicle and the gate may be sealed by a weather strip while the indoor space of the vehicle and the indoor space of the building may be connected to each other.

As a method for achieving the above-described technical problem, according to various exemplary embodiments of the present disclosure, there is provided a docking control method for a vehicle and a building, the docking control method including: setting amount of movement of the vehicle by controlling a plurality of sensors including a vehicle sensor and a gate sensor, when the vehicle approaches a gate; moving the gate so that a vehicle door and the gate may be brought into close contact with each other; and opening, when positional satisfaction between the vehicle door and the gate are achieved, the vehicle door and the gate so that the indoor space of the vehicle and the indoor space of the building may be connected each other into one space.

For example, the vehicle sensor may include a Light Detection and Ranging (LiDAR) sensor, and the gate sensor may include a gate position sensor configured to detect a position of the gate and a gate contact sensor configured to detect whether or not the vehicle door and the gate are in contact with each other.

For example, the setting of the amount of movement of the vehicle may include setting the amount of movement of the vehicle by determining positions of the vehicle door and the gate by the LiDAR sensor of the vehicle and the gate position sensor.

For example, the amount of movement of the vehicle may include an amount of longitudinal movement of the vehicle and an amount of height increase and decrease of the vehicle.

For example, the moving of the gate may be performed by setting amount of transverse movement of the gate, and moving the gate according to the set amount of movement so that the vehicle door and the gate may be brought into close contact with each other.

According to the docking control system for a vehicle and a building and the method therefor of the present disclosure, when the vehicle and the building are docked with each other, the plurality of sensors is used to set the amount of movement of the vehicle and the gate, which is required for docking of the vehicle, so that an docking error of the vehicle and building is compensated and docking may be efficiently performed.

The effect of the present disclosure is not limited to the abovementioned, and other effects not mentioned will be clearly understood by those skilled in the art from the description below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing a vehicle according to various exemplary embodiments of the present disclosure, wherein the vehicle is parked.

FIG. 2 is a view showing a moving state of the vehicle according to the exemplary embodiment of the present disclosure, wherein the vehicle is moved according to a set amount of movement of a vehicle.

FIG. 3 is a view showing a state in which a gate is moved so that a vehicle door and the gate according to the exemplary embodiment of the present disclosure are brought into close contact with each other.

FIG. 4 is a view showing a state in which the vehicle door and the gate are in close contact with each other as the gate according to the exemplary embodiment of the present disclosure is moved.

FIG. 5 is a view showing a state in which when positional satisfaction between the vehicle door and the gate according to the exemplary embodiment of the present disclosure is achieved, the vehicle door and the gate are opened.

FIG. 6 is a flowchart showing a docking control process of a vehicle and a building according to the exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinbelow, exemplary embodiments described in the specification will be described in detail with reference to accompanying drawings, and regardless of the reference numerals, the same reference numerals will refer to the same or like portions, and redundant descriptions thereof will be omitted.

The suffixes “module” and “part” for the components used in the following description are provided or mixed in consideration of only the ease of writing the specification, and do not have distinct meanings or roles by themselves.

In the following description, if it is decided that the detailed description of known function or configuration related to the present disclosure makes the subject matter of the present disclosure unclear, the detailed description is omitted. Furthermore, the accompanying drawings are only for understanding of the exemplary embodiments of the present disclosure, and the technical ideas included in the specification are not limited by the accompanying drawings, and those skilled in the art will appreciate that various modifications, additions and substitutions are possible, without departing from the scope and spirit of the present disclosure as included in the accompanying claims. It will be understood that, although the terms first and/or second, etc. may be used herein to describe various elements, these elements should not be limited by these terms. These terms are only used to distinguish one element, from another element.

It is to be understood that when one element is referred to as being “connected to” or “coupled to” another element, it may be directly connected to or directly coupled to another element or be connected to or coupled to another element, including the other element intervening therebetween. On the other hand, it is to be understood that when one element is referred to as being “directly connected to” or “directly coupled to” another element, it may be connected to or coupled to another element without the other element intervening therebetween.

Singular forms are intended to include plural forms unless the context clearly indicates otherwise.

It will be further understood that the terms “comprises” or “have” used in the present specification, specify the presence of stated features, steps, operations, components, parts, or a combination thereof, but do not preclude the presence or addition of one or more other features, numerals, steps, operations, components, parts, or a combination thereof.

Furthermore, a unit or a control unit included in names such as a motor control unit (MCU), a hybrid control unit (HCU), etc. is only a widely used term for a controller that is configured to control a specific function of a vehicle, and does not mean a generic function unit.

The controller may include a communication device communicating with other controllers or a sensor to control the function in charge, a memory storing an operation system or a logic command and input/output information, and at least one process performing determination, calculation, and decision necessary for controlling the function in charge.

According to various exemplary embodiments of the present disclosure, when a vehicle and a building are docked with each other, the amount of movement of the vehicle and the gate, which is required for docking of the vehicle, is set by use of a plurality of sensors to compensate for a docking error between the vehicle and the building.

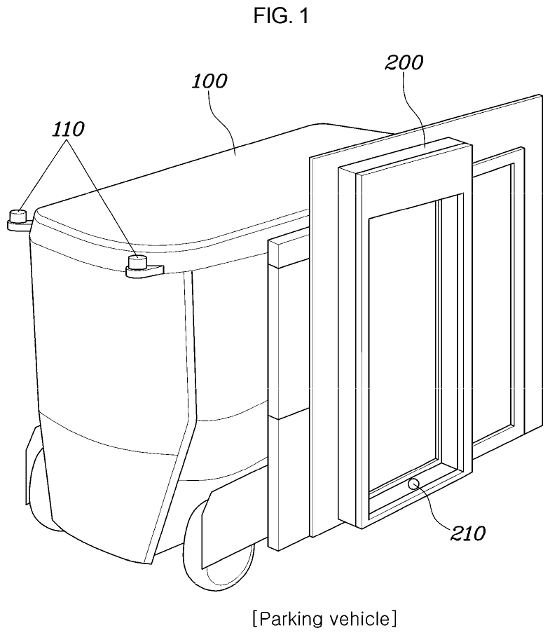

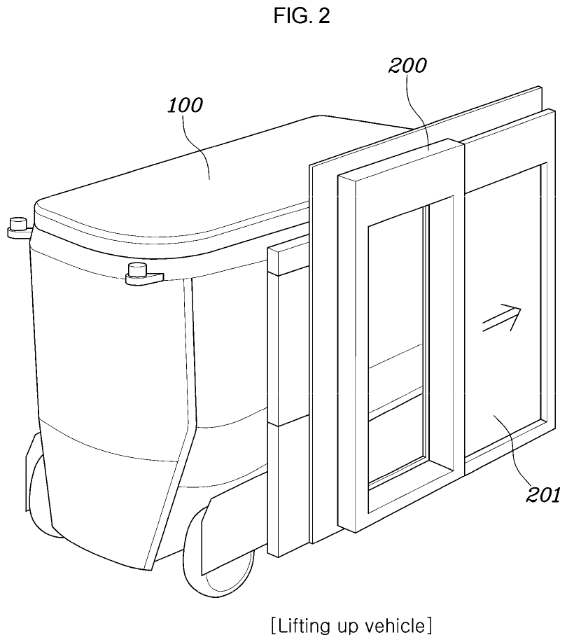

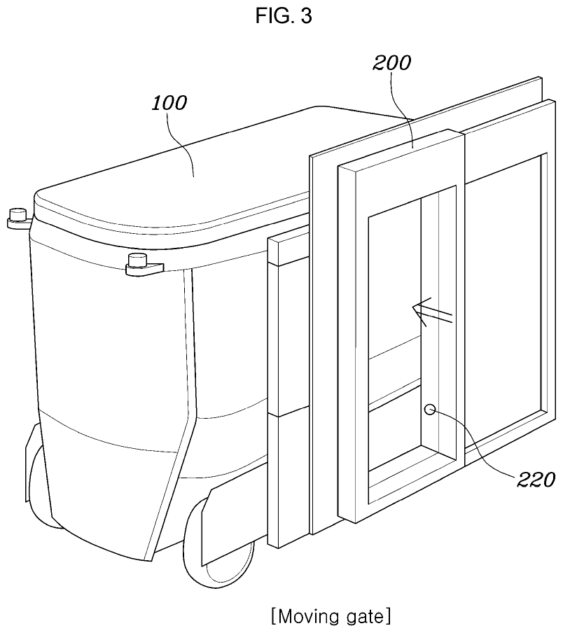

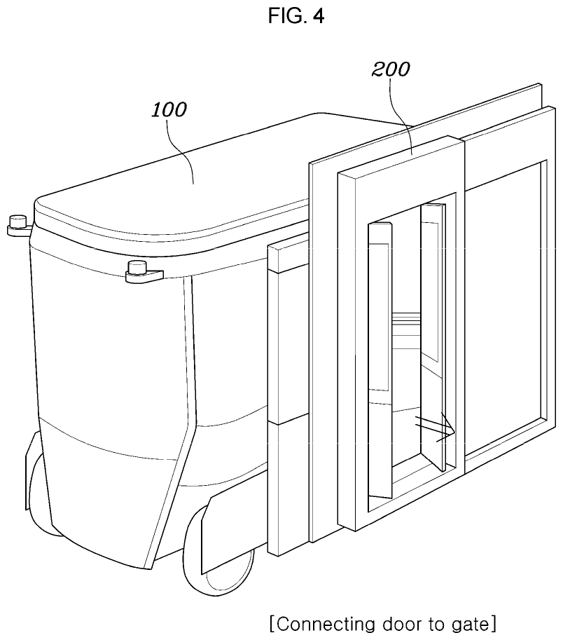

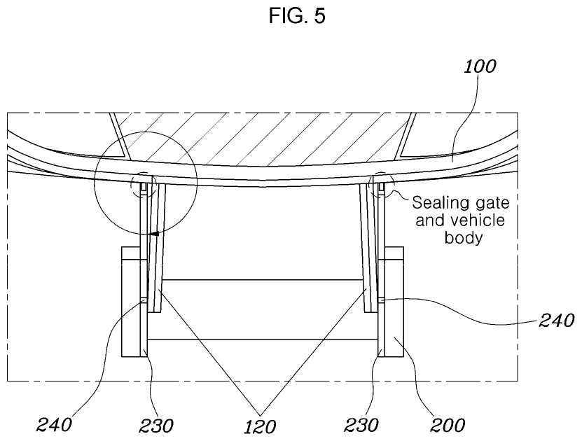

FIG. 1, FIG. 2, FIG. 3, FIG. 4, and FIG. 5 are views showing a control method of a plurality of sensors according to the exemplary embodiment of the present disclosure. Hereinbelow, prior to describing FIG. 1, FIG. 2, FIG. 3, FIG. 4, and FIG. 5, a plurality of sensors forming a docking control system for a vehicle and a building will be described.

First, the plurality of sensors may include a vehicle sensor 110 and a gate sensor 210, 220, 240. Here, the vehicle sensor 110 may be a laser imaging detection and ranging (LiDAR) sensor, and may include not only the LiDAR sensor, but also any sensor configured for detecting a position of the vehicle 100.

Furthermore, the gate sensors 210, 220, 240 may include a gate position sensor 210 detecting a position of a gate 200 and a gate contact sensors 220, 240 detecting whether or not a vehicle door 120 and the gate 200 are in contact with each other. As described below, the gate contact sensors 220, 240 may be divided into an external gate contact sensor 220 detecting whether or not the vehicle 100 and the gate 200 are in contact with each other, and an internal gate contact sensor 240 detecting whether or not the vehicle door 120 and the gate 200 are in contact with each other.

Hereinbelow, a controller forming the docking control system for a vehicle 100 and a building will be described.

FIG. 1 is a view showing a vehicle 100 according to various exemplary embodiments of the present disclosure, wherein the vehicle is parked.

When the vehicle 100 approaches the gate 200, the controller may be configured to control the plurality of sensors to set the amount of movement of the vehicle 100. The vehicle 100 should be completed in parking at a position of the gate 200 where the vehicle is docked with the building. Here, to move the vehicle 100 to a precise position, the controller may set the amount of movement of the vehicle 100 to the position of the gate 200. When the vehicle 100 approaches near to the gate 200 to be in parallel thereto, the vehicle 100 may be moved to the position of the gate 200 only with longitudinal movement of the vehicle 100. Here, the setting, by the controller, of the amount of movement of the vehicle 100 may be achieved by checking X and Y axial positions of the vehicle door 120 and the gate 200 via communication between the LiDAR sensor and the gate position sensor 210.

When it is determined that a distance between the LiDAR sensor of the vehicle 100 and the gate position sensor 210 is far, the controller may set to increase the amount of longitudinal movement of the vehicle 100. When it is determined that the distance is close, the controller may set to decrease the amount of longitudinal movement of the vehicle 100. The vehicle 100 may be configured to be parked at a regular position in auto-control with an internal setting according to the set amount of longitudinal movement.

FIG. 2 is a view showing a moving state of the vehicle 100 according to the exemplary embodiment of the present disclosure, wherein the vehicle is moved according to a set amount of movement of a vehicle 100.

The controller may set not only the amount of longitudinal movement of the vehicle 100, but also the amount of height increase and decrease of the vehicle 100. Even when the vehicle 100 approaches the position of the gate 200 by the amount of longitudinal movement set by the controller, the difference in height between the bottom surfaces of the vehicle 100 and the gate 200. Therefore, like the setting, by the controller, of the amount of longitudinal movement of the vehicle 100, the setting, by the controller, of the amount of height increase and decrease of the vehicle 100 may be performed by checking X and Y axial positions of the vehicle door 120 and the gate 200 via communication between the LiDAR sensor and the gate position sensor 210 shown in FIG. 1. The vehicle 100 may be configured so that the entire vehicle 100 is lifted by an air suspension according to the amount of height increase and decrease set by the controller. Like the parking according to the set amount of longitudinal movement of the vehicle 100, the vehicle 100 may be lifted to the regular position in auto-control with the internal setting according to the set amount of height increase and decrease. At the present point, when lifting of the vehicle 100 is completed, a building-side sliding door 201 may be opened.

Furthermore, FIG. 3 is a view showing a state in which a gate 200 is moved so that a vehicle door 120 and the gate 200 according to the exemplary embodiment of the present disclosure are brought into close contact with each other.

Referring to FIG. 3, the controller may move the gate 200 so that the vehicle door 120 and the gate 200 are brought into close contact with each other while the vehicle 100 is parked. The controller may set the amount of transverse movement of the gate 200 to perform precise docking of the vehicle door 120 and the gate 200 when the vehicle 100 is parked. The controller may move the gate 200 in a transverse direction according to the set amount of transverse movement, so that the vehicle door 120 and the gate 200 are brought into close contact with each other. At the present point, when the controller moves the gate 200, a movement stop logic for the gate 200 is required to consider safety such as preventing people from getting stuck.

The controller may be configured to control the vehicle sensor 110 and the gate position sensor 210, and when detecting an obstacle, may stop movement of the gate 200. When the vehicle sensor 110 and the external gate position sensor 210 detect an obstacle during roof expansion and connection of the gate 200, whether or not the gate 200 is operated is determined via communication between the vehicle sensor 110 and the external gate position sensor 210, and when the external gate position sensor 210 is in close contact with the vehicle 100, movement of the gate 200 may be stopped.

FIG. 4 is a view showing a state in which the vehicle door 120 and the gate 200 are in close contact with each other as the gate 200 according to the exemplary embodiment of the present disclosure is moved. Furthermore, FIG. 5 is a view showing a state in which when positional satisfaction between the vehicle door 120 and the gate 200 according to the exemplary embodiment of the present disclosure is achieved, the vehicle door 120 and the gate 200 are opened.

Referring to FIG. 4, the controller may open the vehicle door 120 and the gate 200 in positional satisfaction of the vehicle door 120 and the gate 200. Here, the controller may open the gate 200 after the vehicle door 120 is opened and may prevent a person located outside the gate 200 from entering the gate 200 before the vehicle door 120 is opened. The vehicle door 120 may be opened while being swung from the inside space of the gate 200 according to the auto control setting so that the safety of a passenger boarding on the vehicle 100 is secured. Furthermore, as shown in FIG. 5, the controller may be configured to control the internal gate contact sensor 240 to determine whether or not the vehicle door 120 is excessively opened. When the vehicle door 120 is in contact with the gate side wall 230, the internal gate contact sensor 240 and the controller communicate with each other to stop excessively opening of the vehicle door 120.

Furthermore, when the vehicle door 120 and the gate 200 are opened and the indoor space of the vehicle 100 and the indoor space of the building are connected each other into one space, as shown in FIG. 5, the gate 200 may be coupled to a vehicle body of the vehicle 100 at the periphery of the vehicle door 120, and a weather strip seals an end portion of the gate 200 so that a portion where the gate 200 and the vehicle body of the vehicle 100 are coupled to each other may be sealed from external noise and dust.

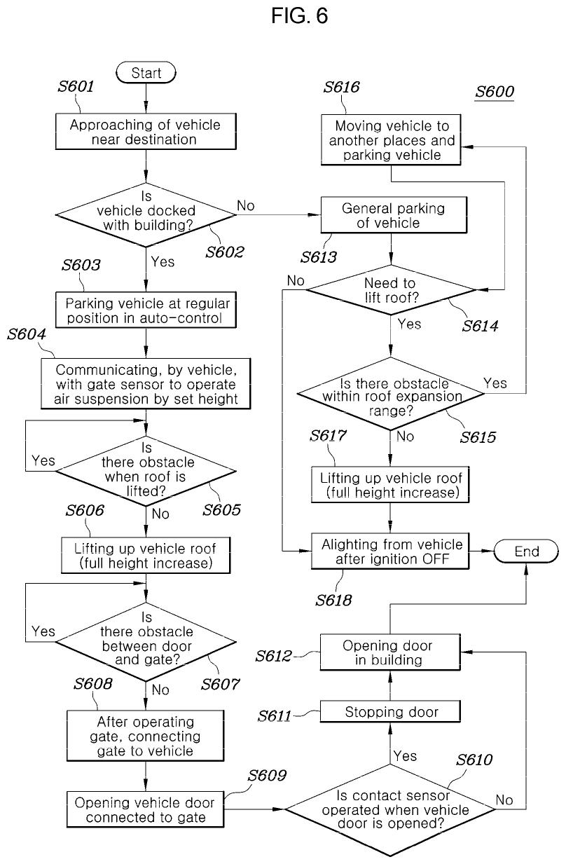

Based on the docking control system for a vehicle 100 and a building as described above, a docking control method for a vehicle 100 and a building according to an exemplary embodiment will be described with reference to FIG. 6.

FIG. 6 is a flowchart showing a docking control process of a vehicle 100 and a building according to the exemplary embodiment of the present disclosure.

Referring to FIG. 6, the vehicle 100 approaches the gate 200 as a destination thereof, at S601. After that, the controller may be configured to determine whether or not the vehicle 100 is docked with the building, at S602. When the vehicle 100 is docked with the building, at YES in S602, the vehicle 100 is moved according to the amount of movement of the vehicle 100, the amount being set by the controller, and the vehicle 100 is parked at the regular position thereof in auto-control, at S603.

After that, the vehicle 100 communicates with the gate position sensor 210 and may operate the air suspension by the amount of height increase and decrease set by the controller, at S604. At the present point, when the air suspension of the vehicle 100 is operated, the controller may be configured to control the vehicle sensor 110 to detect an obstacle located above the vehicle 100, at S605. When the controller detects no obstacle, at NO in S605, the air suspension is operated to lift the vehicle 100 so that the full height may be increased, at S606. After that, the controller may be configured to control the external gate position sensor 210 to detect an obstacle between the vehicle door 120 and the gate 200, at S607. When the controller detects no obstacle, at NO in S607, the controller may operate the gate 200 so that the gate 200 and the vehicle 100 are docked with each other, at S608. After that, the controller is configured to open the vehicle door 120 connected to the gate 200, at S609. Furthermore, the controller may be configured to determine whether or not the contact sensor is operated as the vehicle door 120 is brought into contact with the internal gate contact sensor 240 when the vehicle door 120 is opened, at S610. When the vehicle door 120 is in contact with the internal gate contact sensor 240, at YES in S610, opening of the vehicle door 120 is stopped, at S611, and the door in the building is opened to allow the indoor space of the vehicle 100 and the indoor space of the building to be connected each other into one space, at S612. However, when the vehicle door 120 is not in contact with the internal gate contact sensor 240, at NO in S610, the controller is configured to determine that opening of the vehicle door 120 is in a proper level, immediately opening the door in the building, at S612.

On the other hand, when the vehicle 100 is not docked with the building, at NO in S602, the vehicle 100 may be set into a general parking mode, at S613. After that, the controller may be configured to determine whether or not roof lifting of the vehicle 100 is required, at S614. When the controller determines that rood lifting is required, at YES in S614, the controller may detect whether or not an obstacle exists in a region in which the indoor space of the vehicle 100 expands during roof lifting, at S615. When the controller detects no obstacle, at NO in S615, the air suspension is operated to lift the vehicle 100 so that the full height may be increased, at S617. When the controller detects the obstacle, at YES in S615, the vehicle 100 cannot be lifted and may be controlled to be moved and parted at other places, at S616. After that, the controller is configured to control ignition off of the vehicle 100 and then the passenger in the vehicle alights from the vehicle, at S618.

According to the exemplary embodiments of the present disclosure as described above, during docking of the vehicle and the building, the plurality of sensors are used to set the amount of movement of the vehicle and the gate, the amount being required for docking of the vehicle, to compensate a docking error of the vehicle and the building so that docking of the vehicle and the building may be efficiently performed.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A docking control system for a vehicle and a building, the docking control system comprising:
a plurality of sensors including a vehicle sensor and a gate sensor; and
a controller, wherein when the vehicle approaches a gate, the controller is configured to control the plurality of sensors to set amount of movement of the vehicle, to move the gate so that a vehicle door and the gate are brought into contact with each other, and when positional satisfaction between the vehicle door and the gate is achieved, to open the vehicle door and the gate so that an indoor space of the vehicle and an indoor space of the building are connected each other into one space.

2. The docking control system of claim 1,
wherein the vehicle sensor includes a Light Detection and Ranging (LiDAR) sensor, and
wherein the gate sensor includes a gate position sensor configured to detect a position of the gate and a gate contact sensor configured to detect whether the vehicle door and the gate are in contact with each other.

3. The docking control system of claim 2, wherein the controller is further configured to determine positions of the vehicle door and the gate by the LiDAR sensor of the vehicle and the gate position sensor to set the amount of movement of the vehicle.

4. The docking control system of claim 3, wherein the amount of movement of the vehicle includes an amount of longitudinal movement of the vehicle and an amount of height increase and decrease of the vehicle.

5. The docking control system of claim 2, wherein the controller is further configured to control the vehicle sensor and the gate position sensor, and when an obstacle is detected, the controller is further configured to stop movement of the gate.

6. The docking control system of claim 2, wherein the controller is further configured to control the gate contact sensor, and when the vehicle door is in contact with a side wall of the gate, the controller is further configured to stop opening of the vehicle door.

7. The docking control system of claim 2, wherein the gate contact sensor includes an external gate contact sensor detecting whether the vehicle and the gate are in contact with each other, and an internal gate contact sensor detecting whether the vehicle door and the gate are in contact with each other.

8. The docking control system of claim 1, wherein the controller is further configured to set amount of transverse movement of the gate, and move the gate according to the set amount of traverse movement, so that the vehicle door and the gate are brought into contact with each other.

9. The docking control system of claim 1, wherein when the positional satisfaction between the vehicle door and the gate is achieved, the controller is further configured to open the gate after the vehicle door is opened.

10. The docking control system of claim 9, wherein the vehicle door is configured to be opened while being rotated from an inner space of the gate.

11. The docking control system of claim 1, wherein a vehicle body of the vehicle and the gate are sealed by a weather strip while the indoor space of the vehicle and the indoor space of the building are connected to each other.

12. A docking control method for a vehicle and a building, the docking control method comprising:
setting, by a controller, amount of movement of the vehicle by controlling a plurality of sensors including a vehicle sensor and a gate sensor, when the vehicle approaches a gate;
moving, by the controller, the gate so that a vehicle door and the gate are brought into contact with each other; and
opening, by the controller, when positional satisfaction between the vehicle door and the gate are achieved, the vehicle door and the gate so that an indoor space of the vehicle and an indoor space of the building are connected each other into one space.

13. The docking control method of claim 12,
wherein the vehicle sensor includes a Light Detection and Ranging (LiDAR) sensor, and
wherein the gate sensor includes a gate position sensor configured to detect a position of the gate and a gate contact sensor configured to detect whether the vehicle door and the gate are in contact with each other.

14. The docking control method of claim 13, wherein the gate contact sensor includes an external gate contact sensor detecting whether the vehicle and the gate are in contact with each other, and an internal gate contact sensor detecting whether the vehicle door and the gate are in contact with each other.

15. The docking control method of claim 13, wherein the setting of the amount of movement of the vehicle includes:
setting the amount of movement of the vehicle by determining positions of the vehicle door and the gate by the LiDAR sensor of the vehicle and the gate position sensor.

16. The docking control method of claim 15, wherein the amount of movement of the vehicle includes an amount of longitudinal movement of the vehicle and an amount of height increase and decrease of the vehicle.

17. The docking control method of claim 13, wherein the moving of the gate is performed by:
setting amount of transverse movement of the gate, and moving the gate according to the set amount of transverse movement so that the vehicle door and the gate are brought into contact with each other.
